(19) United States
(12) Patent Application Publication
(10) Pub. No.: US 2006/0284472 A1
(43) Pub. Date: Dec. 21, 2006

(54) Brakable wheel hub device

(75) Inventor: Hubert Chen, Taichung (TW)

Correspondence Address: DLA PIPER RUDNICK GRAY CARY US, LLP, 2000 UNIVERSITY AVENUE, E. PALO ALTO, CA, 94303-2248, US

(73) Assignee: KUN TENG INDUSTRY CO., LTD.

(21) Appl. No.: 11/156,037

(22) Filed: Jun. 16, 2005

(51) Int. Cl. B60B 19/00

(52) U.S. Cl. 301/6.9

(57) ABSTRACT

A brakable wheel hub device includes a wheel hub shell having an axially extending disk securing region and a threaded region proximate to an inserting end region. A mount unit extends outwardly and radially from the disk securing region, and has a plurality of angularly displaced abutted regions. A plurality of positioning stubs extend axially from the abutted regions respectively, and are inserted into through holes formed in a brake disk such that a proximate major surface of the brake disk abuts against the abutted regions. A tightening member includes an axially extending threaded segment which is insertable into a mounting hole in the brake disk so as to threadedly engage the threaded region, and an abutting wall which extends radially and outwardly from the threaded segment to press a distal major surface of the brake disk towards the abutted regions.

### BACKGROUND OF THE INVENTION

1. Field of the Invention

This invention relates to a brakable wheel hub device, more particularly to a brakable wheel hub device adapted to detachably secure a brake disk so as to be rotatably mounted on a wheel axle of a bicycle.

2. Description of the Related Art

A conventional bicycle wheel hub, such as that disclosed in U.S. Pat. No. 6,371,252 B1 and U.S. Pat. No. 6,571,920 B1, is coupled to a brake disk to be rotatably mounted on a wheel axle of a bicycle, and generally includes a hub shell rotatably coupled to a hub axle, and having external peripheral splines, and a positioning adapter having internal surrounding splines to engage the external peripheral splines, and a connecting surface for fixing the brake disk. Due to the particular construction of the hub shell, manufacturing cost is relatively high.

To improve this problem, in U.S. Pat. No. 6,854,569 B2, the applicant disclosed a brakable wheel hub device that comprises a hub shell adapted to be rotatably mounted on an axle, and having a disk securing portion which has an internally threaded section and a plurality of insert holes at a right end thereof that contacts a brake disk. A positioning ring is disposed outboard to the brake disk, and has a plurality of axially extending protrusions which pass through the brake disk and which are fitted into the insert holes so as to place the brake disk in a spline engagement with the hub shell. A surrounding locking member has an insert segment with an externally threaded section to threadedly engage the internally threaded section through the brake disk, and an abutting segment to abut against the positioning ring, thereby securing the brake disk relative to the hub shell.

It is desirable to have an improved brakable wheel hub device that has a simple construction for convenient assembling and disassembling, and that can reduce impacts resulting from a shearing force acting on a connection between the brake disk and the hub shell during a braking action.

### SUMMARY OF THE INVENTION

The object of the present invention is to provide a brakable wheel hub device which has a simple construction to facilitate assembly and disassembly, which can reduce impacts resulting from a shearing force acting on a connection between a brake disk and a wheel hub shell, and which can effectively stabilize the brake disk during a braking action.

According to this invention, the brakable wheel hub device includes a wheel hub shell having a tubular wall segment which is adapted to secure a brake disk, and which includes outer and inner surrounding wall surfaces opposite to each other in radial directions relative to an axis. The outer surrounding wall surface includes a flange mounting region adapted to anchor a plurality of spokes of a bicycle, and a disk securing region which extends from the flange mounting region in the axial direction to terminate at an inserting end region. The tubular wall segment has a threaded region proximate to the inserting end region. A mount unit is disposed to extend outwardly and radially from the disk securing region, and includes an abutted wall that faces in the axial direction and away from the flange mounting region, and that includes a plurality of abutted regions angularly displaced from one another about the axis. A plurality of positioning stubs are disposed to extend respectively from the abutted regions in an axial direction, and are adapted to be inserted respectively into through holes formed in the brake disk such that a proximate major surface of the brake disk is brought to abut against the abutted regions. A tightening member includes a threaded segment which has leading and trailing ends opposite to each other in the axial direction, and is configured to be insertable into a mounting hole formed in the brake disk so as to threadedly engage the threaded region, and an abutting wall which extends radially and outwardly from the trailing end such that when the proximate major wall surface is brought to abut against the abutted regions upon fitting of the positioning stubs into the through holes, respectively, a screw-in movement of the threaded segment relative to the threaded region will bring the abutting wall to press the distal major surface towards the abutted wall, thereby ensuring a firm connection between the proximate major surface and the abutted regions.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a partly cutaway exploded perspective view of the first preferred embodiment of a brakable wheel hub device according to this invention;

FIG. 2 is a schematic side view of the first preferred embodiment of this invention;

FIG. 3 is a partly cutaway exploded perspective view of the second preferred embodiment of a brakable wheel hub device according to this invention; and

FIG. 4 is a schematic side view of the second preferred embodiment of this invention.

### DETAILED DESCRIPTION OF THE PREFERRED EMBODIMENTS

Before the present invention is described in greater detail, it should be noted that same reference numerals have been used to denote like elements throughout the specification.

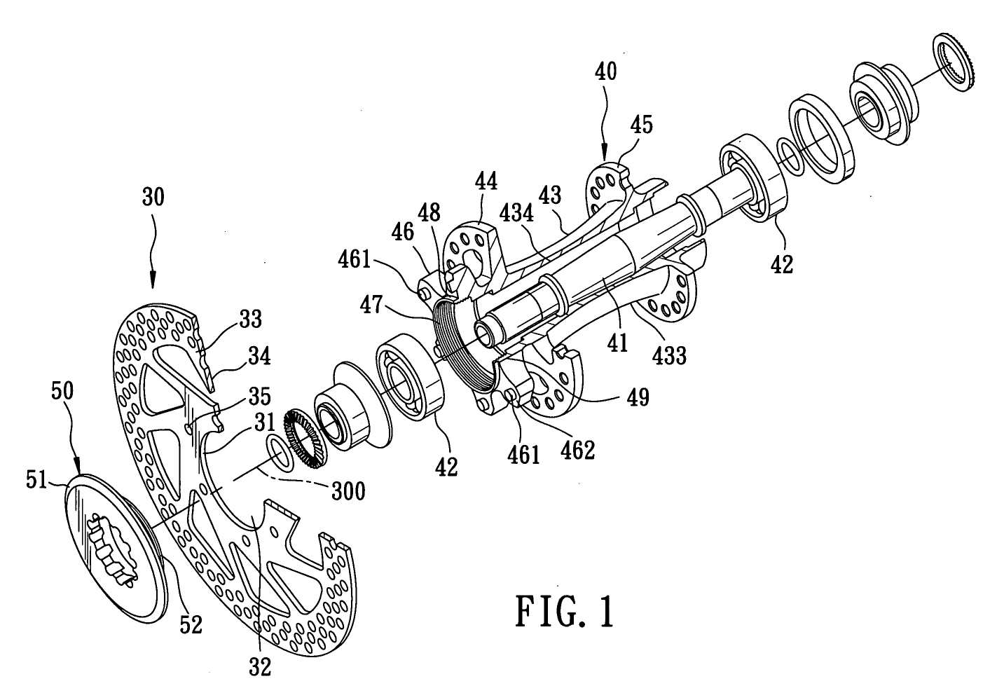

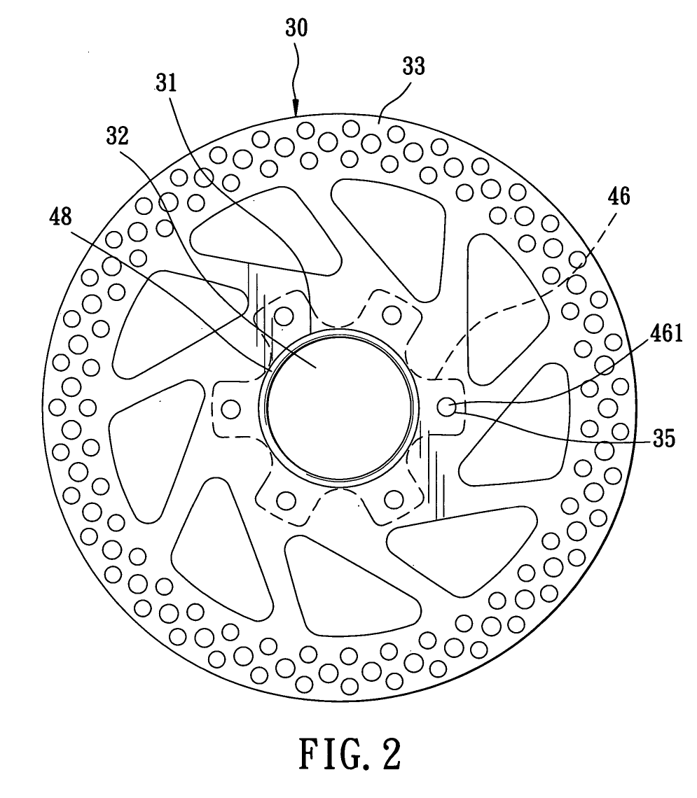

Referring to FIGS. 1 and 2, the first preferred embodiment of a brakable wheel hub device according to the present invention is adapted to secure a brake disk 30, and is rotatable relative to an axle 41 about an axis 300 by means of anti-friction bearings 42. The brakable wheel hub device is shown to comprise a wheel hub shell 40, a mount unit 46, six positioning stubs 461, and a tightening member 50.

The brake disk 30 is a standard brake disk, and has proximate and distal major surfaces 34, 33 opposite to each other in an axial direction, and an inner peripheral wall 31 surrounding the axis 300 to define a mounting hole 32 that passes through the proximate and distal major surfaces 34, 33. The brake disk 30 has six through holes 35 which are offset from the mounting hole 32, and which are angularly displaced from one another about the axis 300.

The wheel hub shell 40 has a tubular wall segment 43 which is adapted to secure the brake disk 30, and which includes outer and inner surrounding wall surfaces 433, 434 opposite to each other in radial directions relative to the axis 300. The outer surrounding wall surface 433 includes two axially opposite flange mounting regions 44, 45 for anchoring a plurality of spokes (not shown) of a bicycle, and a disk securing region 49 which extends from the flange mounting region 44 in the axial direction to terminate at an inserting end region 48. The inner surrounding wall surface 434 has an internally threaded region 47 proximate to the inserting end region 48.

The mount unit 46 is integrally formed with and extends outwardly and radially from the disk securing region 49, and includes six toothed portions which are angularly spaced apart from one another about the axis 300 and which respectively serve as abutted regions 462 that face in the axial direction and away from the flange mounting region 44 to form an abutted wall.

Each of the positioning stubs 461 is integrally formed with and extends from a respective one of the abutted regions 462 in the axial direction, and is adapted to be inserted into a respective one of the through holes 35 in the brake disk 30 such that the proximate major surface 34 of the brake disk 30 is brought to abut against the abutted regions 462. The inserting end region 48 is adapted to be inserted into the mounting hole 32 so as to be surrounded by the inner peripheral wall 31.

The tightening member 50 includes an externally threaded segment 52 in the form of an externally threaded surface which has leading and trailing ends opposite to each other in the axial direction, and which is configured to be insertable into the mounting hole 32 so as to threadedly engage the internally threaded region 47, and an abutting wall 51 which extends radially and outwardly from the trailing end of the externally threaded segment 52. Thus, when the proximate major wall surface 34 of the brake disk 30 is brought to abut against the abutted regions 462 upon fitting of the positioning stubs 461 onto the through holes 35, respectively, a screw-in movement of the externally threaded segment 52 relative to the internally threaded region 47 will bring the abutting wall 51 to press the distal major surface 33 towards the abutted wall of the mount unit 46, thereby ensuring a firm connection between the proximate major surface 34 and the abutted regions 462.

In assembly, the positioning stubs 461 are inserted into the through holes 35 while the inserting end region 48 is inserted into the mounting hole 32. The externally threaded segment 52 is then screwed into the internally threaded region 47 so as to bring the abutting wall 51 to press the distal major surface 33 of the brake disk 30 and to bring the proximate major surface 34 to abut against the abutted regions 462. Therefore, the assembling operation is convenient and easy to conduct. Moreover, the brakable wheel hub device of this invention is easy to manufacture, and can be used with a standard brake disk 30. Furthermore, with the construction as illustrated, during the braking action, an impact resulting from a shearing force acting on the connection between the braking disk 30 and the positioning stubs 461 can be reduced so as to prevent damage to the positioning stubs 461.

Furthermore, the internally threaded region 47 and the externally threaded segment 52 may be interchanged with each other, i.e., the externally and internally threaded surfaces are formed on the wheel hub shell 40 and the tightening member 50, respectively.

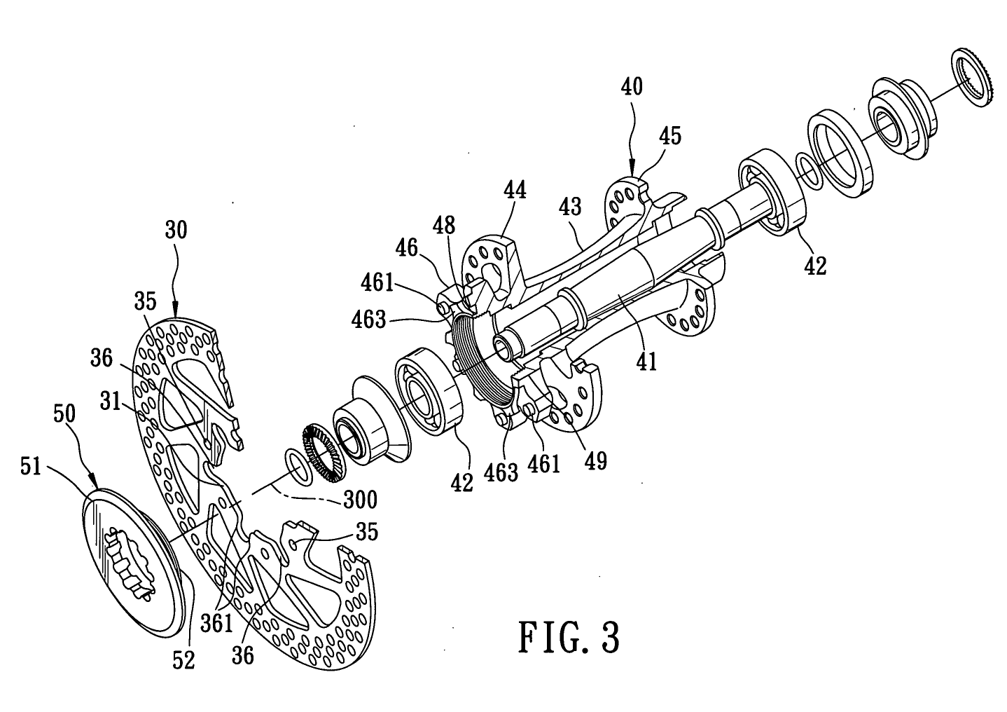

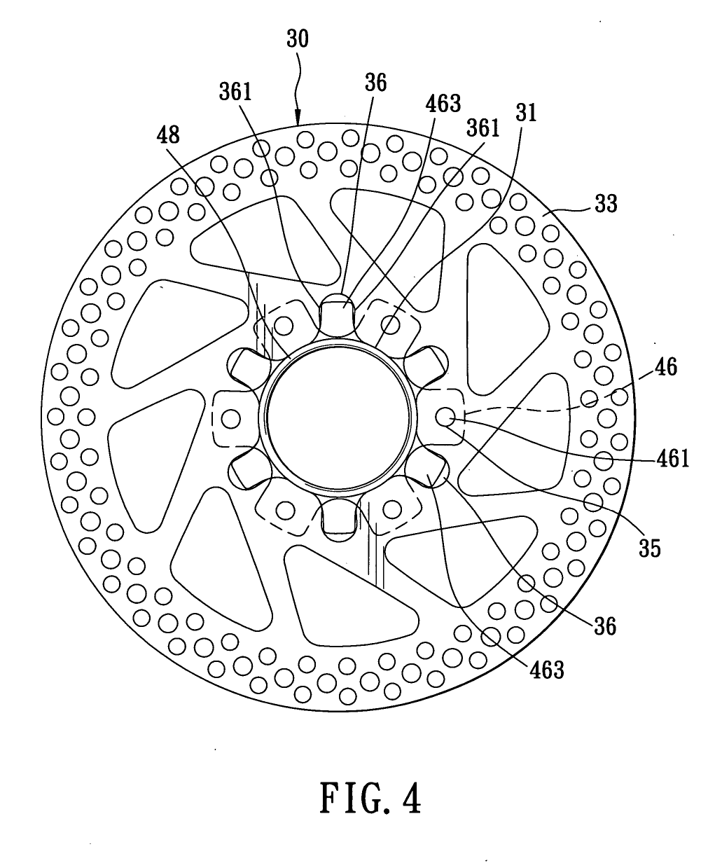

Referring to FIGS. 3 and 4, the second preferred embodiment of a brakable wheel hub device according to this invention is shown to be similar to the aforesaid embodiment in construction. This embodiment is adapted to secure a brake disk 30 which further has six cutout portions 36 that extend radially and outwardly from the inner peripheral wall 31. Each of the cutout portions 36 is formed between two adjacent ones of the through holes 35, and includes two lateral areas 361 which are spaced apart from each other in a circumferential line that surrounds the inner peripheral wall 31. This embodiment further comprises six brake stabilizing members 463 which extend outwardly and radially from the disk securing region 49, and which are proximate to the inserting end region 48. The braking stabilizing members 463 are each disposed between two adjacent ones of the positioning stubs 461 such that when the positioning stubs 461 are inserted into the through holes 35, respectively, each of the brake stabilizing members 463 is fitted into a respective one of the cutout portions 36 and engages the lateral areas 361 of the respective one of the cutout portions 36, thereby stabilizing the brake disk 30 during a braking action.

It is noted that the number of the brake stabilizing members 463 may be varied as long as the brake stabilizing members 463 are disposed opposite to each other relative to the axis 300. While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

I claim:

1. A brakable wheel hub device which is rotatable about an axis, and which is adapted to secure a brake disk that has proximate and distal major surfaces opposite to each other in an axial direction, and an inner peripheral wall surrounding the axis to define a mounting hole that passes through the proximate and distal major surfaces, the brake disk having a plurality of through holes which are offset from the mounting hole, and which are angularly displaced from one another about the axis, said brakable wheel hub device comprising:
a wheel hub shell having a tubular wall segment which is adapted to secure the brake disk, and which includes outer and inner surrounding wall surfaces opposite to each other in radial directions relative to the axis, said outer surrounding wall surface including a flange mounting region adapted to anchor a plurality of spokes of a bicycle, and a disk securing region which extends from said flange mounting region in the axial direction to terminate at an inserting end region, said tubular wall segment having a threaded region proximate to said inserting end region;
a mount unit which is disposed to extend outwardly and radially from said disk securing region, and which includes an abutted wall that faces in the axial direction and away from said flange mounting region, and that includes a plurality of abutted regions angularly displaced from one another about the axis;
a plurality of positioning stubs which are disposed to extend respectively from said abutted regions in the axial direction, and which are adapted to be inserted respectively into the through holes such that the proximate major surface is brought to abut against said abutted regions; and
a tightening member including a threaded segment which has leading and trailing ends opposite to each other in the axial direction, and which is configured to be adapted to be insertable into the mounting hole so as to threadedly engage said threaded region, and an abutting wall which extends radially and outwardly from said trailing end such that when the proximate major wall surface is brought to abut against said abutted regions upon fitting of said positioning stubs into the through holes, respectively, a screw-in movement of said threaded segment relative to said threaded region will bring said abutting wall to press the distal major surface towards said abutted wall, thereby ensuring a firm connection between the proximate major surface and said abutted regions.

2. The brakable wheel hub device of claim 1, wherein said inserting end region is configured to be adapted to be insertable in the mounting hole so as to be surrounded by the inner peripheral wall when the proximate major surface is brought to abut against said abutted regions.

3. The brakable wheel hub device of claim 2, wherein said threaded region of said tubular wall segment is formed on said inner surrounding wall surface, said threaded segment of said tightening member being in form of an externally threaded surface which is configured to threadedly engage said threaded region formed on said inner surrounding wall surface.

4. The brakable wheel hub device of claim 1, wherein said abutted wall includes a plurality of toothed portions which are angularly spaced apart from one another about the axis so as to serve as said abutted regions, respectively.

5. The brakable wheel hub device of claim 1, wherein said mount unit is integrally formed with said disk securing region.

6. The brakable wheel hub device of claim 1, wherein said positioning stubs are integrally formed with said abutted wall.

7. A brakable wheel hub device rotatable about an axis, comprising:
a brake disk having proximate and distal major surfaces opposite to each other in an axial direction, and an inner peripheral wall surrounding the axis to define a mounting hole that passes through said proximate and distal major surfaces, said brake disk having a plurality of through holes which are offset from said mounting hole, and which are angularly displaced from one another about the axis;
a wheel hub shell having a tubular wall segment which includes outer and inner surrounding wall surfaces opposite to each other in radial directions relative to the axis, said outer surrounding wall surface including a flange mounting region adapted to anchor a plurality of spokes of a bicycle, and a disk securing region which extends from said flange mounting region in the axial direction to terminate at an inserting end region that is insertable in the mounting hole, said tubular wall segment having a threaded region proximate to said inserting end region;
a mount unit which is disposed to extend outwardly and radially from said disk securing region, and which includes an abutted wall that faces in the axial direction and away from said flange mounting region, and that includes a plurality of abutted regions angularly displaced from one another about the axis;
a plurality of positioning stubs which are disposed to extend respectively from said plurality of abutted regions in the axial direction, and which are configured to be inserted respectively into said through holes such that said proximate major surface is brought to abut against said abutted regions; and
a tightening member including a threaded segment which has leading and trailing ends opposite to each other in the axial direction, and which is configured to be insertable into said mounting hole so as to threadedly engage said threaded region, and an abutting wall which extends radially and outwardly from said trailing end such that when said proximate major wall surface is brought to abut against said abutted regions upon fitting of said positioning stubs into said through holes, respectively, a screw-in movement of said threaded segment relative to said threaded region will bring said abutting wall to press said distal major surface towards said abutted wall, thereby ensuring a firm connection between said proximate major surface and said abutted regions.

8. The brakable wheel hub device of claim 7, wherein said brake disk includes a plurality of cutout portions, each of which extends radially and outwardly from said inner peripheral wall and is formed between two adjacent ones of said through holes and includes two lateral areas spaced apart from each other in a circumferential line that surrounds said inner peripheral wall, said brakable wheel hub device further comprising a plurality of brake stabilizing members which extend outwardly and radially from said disk securing region, and which are proximate to said inserting end region, said braking stabilizing members being each disposed between two adjacent ones of said positioning stubs such that when said positioning stubs are inserted into said through holes, respectively, each of said brake stabilizing members is fitted into a respective one of said cutout portions and engages said lateral areas of the respective one of said cutout portions, thereby stabilizing said brake disk during a braking action.
